(19) United States
(12) Patent Application Publication
(10) Pub. No.: US 2009/0274397 A1
(43) Pub. Date: Nov. 5, 2009

(54) Disposable pet-waste containment bag

(75) Inventor: Bonnie JoAnn Wong, Lake Grove, NY (US)

Correspondence Address: Bonnie J. Wong, 7 Tiffany Court, Lake Grove, NY, 11755, US

(73) Assignee: Bonnie Wong, Lake Grove, NY (US)

(21) Appl. No.: 12/418,463

(22) Filed: Apr. 3, 2009

Related U.S. Application Data
(60) Provisional application No. 61/124,767, filed on Apr. 21, 2008.

(51) Int. Cl. B65D 33/00

(52) U.S. Cl. 383/33

(57) ABSTRACT

The disposable pet-waste containment bag is a disposable apparatus that adheres around the perimeter of the birdcage to collect the waste that falls and collects a notable distance from the interior of the cage where the birds reside. The used bag is quickly detached and easily disposed by folding all sides of the used bag toward the center to contain the waste upon removal, which keeps the pet cleaner and reduces cleanup time.

### BACKGROUND OF THE INVENTION

1. Field of the Invention

The present invention collects pet waste and dropped food in the disposable apparatus that is affixed beneath an animal habitat constructed with a fall through floor such as a birdcage. The disposable pet-waste containment bag helps prevent these particles from scattering on the floor around the cage, saving the pet owner time by disposing the bag after removal, creating a healthier and cleaner environment for the pet.

2. Description of Related Art

Clarizo U.S. Pat. No. 4,572,107 easily cleanable animal enclosure incorporates a funnel member, a base, detachable sack, inner bag, and requires newspaper placement within the funnel. Watts US Patent 428536 and Watts U.S. Pat. No. 6,269,775 animal cage guard is not disposable, comprised in part of a mesh netting and an elastomeric band, and requires additional fasteners, and designed to envelope the cage, which does not place distance between the waste and the pet, but rather holds in the gases created from waste and confines the plumes of dust to the interior of the cage. Brindamour U.S. Pat. No. 5,088,445 animal cage cover and litter catcher comprised of sheet is not disposable and employs a frame and fasteners. Macleod U.S. Pat. No. 3,672,332 disposable floor dispenser for birdcage is a spindled dispenser with flap containing a roll of floor material in the bottom of the tray, which replaces newspaper usage. Kearney U.S. Pat. No. 2,045,472 birdcage protector is not disposable, comprised of fabric body, and utilizes hooks. Wheeler U.S. Pat. No. 4,027,625 pet commode is a rigid base or box that supports a plastic bag suitable for containing litter. The commode is multiple contraptions including a slideable tray, a closure, a lower opening, and spring clips. These devises listed as related art, either requires additional members and attachments to support the contraption or contains moving parts, none of which are as convenient as the present invention, and due to the initial investment of the related art, none are as economical as the present invention.

Over four years, I have consistently and successfully used prototypes of present invention on my birds' cage. The present invention is a disposable plastic wide-mouthed bag for use with a birdcage or similarly designed habitats constructed without a solid bottom. The present invention drastically reduces cleaning time because there is no tray, no liner, and no additional pieces. The present invention provides an alternate changing method that keeps the bird cleaner and healthier due in part to the significant distance of the accumulated waste from the interior of the cage where the pet resides. The fall-through floor of the cage allows the animal waste and unwanted particles to fall directly into the present disposable bag invention mounted beneath the bottom of the cage. The waste rests a significant distance beneath the pet due to the depth of the bag, therefore creating a more hygienic habitat.

In addition to being a healthier alternative, the present invention gives economic time saving convenience to pet owners. Changing the liner of a birdcage can be a time consuming and messy task. Traditional liners may give or bend allowing droppings to fall onto the owner of the floor. They may also be thin, allowing drippings to seep through onto the floor, which will necessitate more cleaning by the consumer. Pan liners keep birds close to their waste, which can create health concerns for the pet. Some owners use litter in place of traditional paper. These litters are made from ground shell chips, sawdust and woodchips, or sand, which can be messy to change or clean, and contribute to respiratory ailments or accidental ingestion of the liter.

The present invention is a wide-mouthed bag that employs a peel-off-self-adhesive strip to secure the bag around the perimeter of the birdcage beneath the interior where the pet resides, allowing the animal waste to fall directly into the disposable bag which is quickly and easily removed by folding all sides of the bag toward the center to contain the waste, then disposed, which saves the consumer time and eliminates the use of the shallow cage tray.

### SUMMARY OF INVENTION

The primary problem creating the necessity for the disposable waste containment bag is the waste management issues bird owners' face on a daily basis. The disposable pet-waste containment bag helps reduce dispersal of excretions, seed, and all substances that would normally accumulate on the floor around the birdcage. In addition to reducing the mess, the disposable waste containment bag is so convenient it takes minutes to clean and remove droppings from the cage by folding all sides of the bag toward the center to contain the waste, then dispose of the used bag at the owners discretion, approximately every five to nine days. The disposable pet-waste bag has health benefits because of the depth of the bag, the bird resides a significant distance above its droppings. At any given time, there is no need for use of anything more than the one disposable bag, unlike previously listed related art. Items currently on the market being used for excretions are liners or litter. Liners constructed of plastic or paper are too thin and may allow seepage, or the liners may bend allowing drippings to fall onto the floor, necessitating more cleaning by the consumer. Litter is made from ground shell chips, sawdust, or sand, all of which are unhealthy and messy. Liners and litter utilize the shallow tray, which rests mere inches beneath the bird, keeping the pet close to their waste or dusty litter, which may become a health hazard. The pet-waste containment bag provides an alternative that keeps the bird cleaner and reduces cleaning time.

### BRIEF DESCRIPTION OF THE DRAWINGS

FIG. 1 angled three-dimensional view of waste containment bag

FIG. 2 angled three-dimensional view of cage and waste containment bag.

FIG. 3 frontal view of cage and waste containment bag.

FIG. 4 hanging birdcage and suspended waste containment bag.

### DETAILED DESCRIPTION OF THE INVENTION

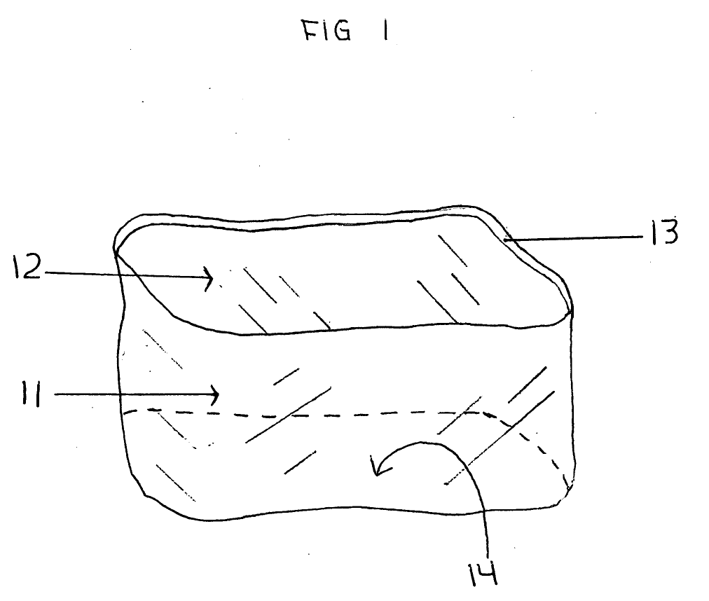

The waste containment bag FIG. 1 is comprised of four parts, the body 11, loosely opened to display the top opening, or mouth 12, and the self-adhesive strip 13 around the perimeter of the mouth, and the bottom of the bag 14, where the bird waste accumulates.

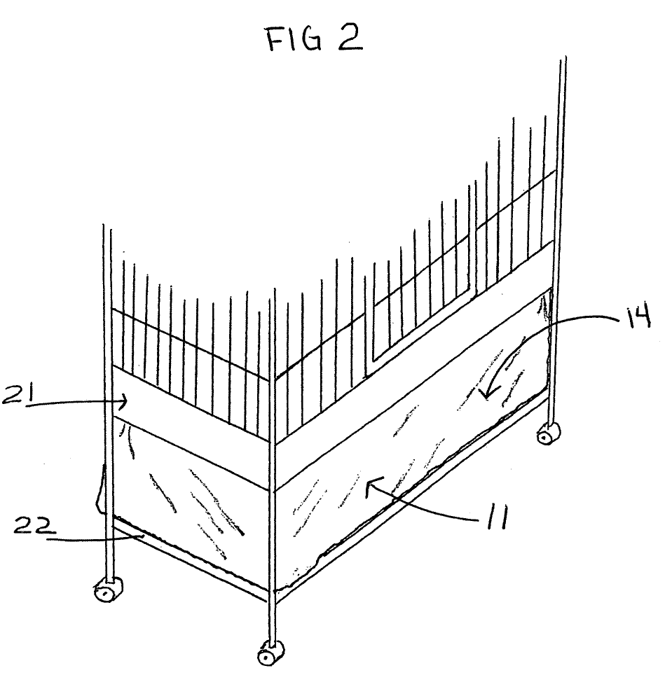

In FIG. 2 the perimeter of the mouth lined with the self adhesive strip is adhered to the perimeter of the bird cage 21, which also depicts how the body of the bag 11 takes the shape of the cage and with the assist of gravity, the body 11 drapes downward to rest on the lower cage rack 22, where the bottom 14 of the waste containment bag collects the bird waste a notable distance from the cage interior where the birds reside.

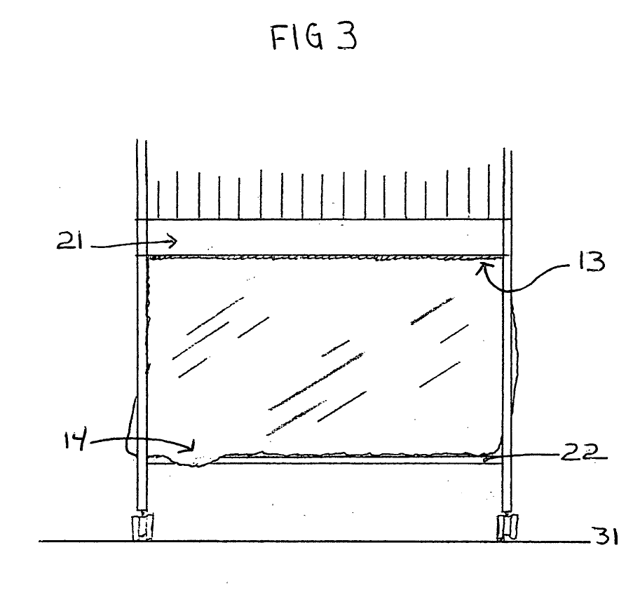

In FIG. 3, the waste containment bag FIG. 1 is adhered to the frame of a birdcage 21 via a self-adhesive strip 13. The bottom of the bag 14 rests on the lower cage rack 22, a notable distance from the cage interior where the birds reside. Depending on the construction of the cage, due to the flexible nature of the waste containment bag, depth of the bag will allow the bottom 14 to rest on the floor 31 if the cage was factory constructed without a lower, rack.

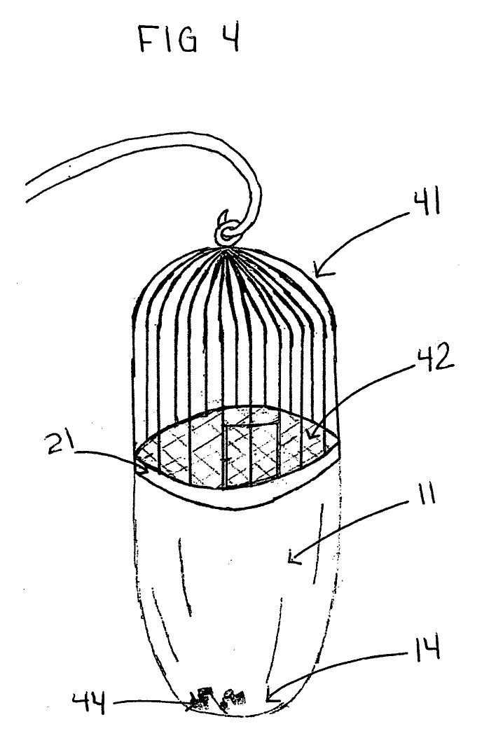

In FIG. 4 a waste containment bag FIG. 1 adhered to the frame 21 of a hanging circular bird cage 41, depicting the flexible nature of the body 11 of the suspended waste containment bag FIG. 1 as the bag drapes downward, the waste 44 drops through the fall-through floor 42, and accumulates in the bottom of the bag 14, a notable distance from the cage interior where the birds reside.

1. Disposable pet-waste containment bag FIG. 1 is comprised of a thin non-porous plastic with a large mouth of said bag temporarily affixed on the perimeter of the cage at the bottom of the interior.

2. Disposable pet-waste containment bag of claim 1 is temporarily adhered to the cage by the self-adhesive strip around the edge of the mouth of said bag.

3. Disposable pet-waste containment bag of claim 2 can be used for floor model cages as depicted in FIG. 3, or adhered to suspended cages as depicted in FIG. 4.

4. Disposable pet-waste containment bag of claim 3 can be used for any habitat without a solid bottom, including bird cages and rabbit hutches, allowing pet waste to fall directly into the bag.

5. Disposable pet-waste containment bag of claim 1 is biodegradable.

6. Disposable pet-waste containment bag of claim 3 available in a variety of colors or designs.

7. Disposable pet-waste containment bag of claim 2 available in a variety of sizes to accommodate small to large cages.
